(19) United States
(12) Patent Application Publication
(10) Pub. No.: US 2019/0203846 A1
(43) Pub. Date: Jul. 4, 2019

(54) HIGH FLOW HIGH PRESSURE HYDRAULIC SOLENOID VALVE FOR AUTOMATIC TRANSMISSION

(71) Applicant: BorgWarner Inc., Auburn Hills, MI (US)

(72) Inventors: Mitsuru ISHIHARA, Novi, MI (US); Jeffrey J. WATERSTREDT, Royal Oak, MI (US)

(21) Appl. No.: 16/093,157

(22) PCT Filed: Apr. 6, 2017
(86) PCT No.: PCT/US2017/026315

§ 371 Date: Oct. 12, 2018

Related U.S. Application Data
(60) Provisional application No. 62/321,257, filed on Apr. 12, 2016.

(51) Int. Cl. F16K 31/06; F16K 27/04; F16K 11/07; F16H 61/02

(52) U.S. Cl. CPC F16K 31/0613; F16K 27/048; F16H 2061/0253; F16K 27/041; F16H 61/0251; F16K 11/0716

(57) ABSTRACT

A high flow high pressure hydraulic solenoid valve (26) includes a proportional 5 solenoid (56) and a valve body (30) operatively associated with the solenoid (56). The valve body (30) has a valve bore (32) and at least two fluid ports (38, 40) for fluid communication with the valve bore (32), wherein one of the at least two fluid ports (38, 40) includes an undercut (38b, 40b). The high flow high pressure hydraulic solenoid valve (26) also includes a valve member (42) 10 axially and slidingly disposed within the valve bore (32). The valve member (42) has a plurality of valve elements (44) spaced axially along the valve member (42). At least one of the valve elements (44) has a metering face (76a, 76c) acting with the undercut (38b, 40b). The one of the at least two fluid ports (38, 40) has two openings (82) located approximately one hundred eighty (180) degrees from each other in the valve body (30) and the valve member (42) has a control 15 module port (49a) configured to be ninety degrees from the at least one fluid port to balance pressure on the valve member (42) during high flow conditions.

### BACKGROUND OF INVENTION

### 1. Field of Invention

The present invention relates generally to automatic transmissions and, more specifically, to a high flow high pressure hydraulic solenoid valve for an automatic transmission.

### 2. Description of the Related Art

Conventional vehicles known in the art typically include an engine having a rotational output that provides a rotational input into a transmission such as an automatic transmission for a powertrain system of the vehicle. The transmission changes the rotational speed and torque generated by an output of the engine through a series of predetermined gearsets to transmit power to one or more wheels of the vehicle, whereby changing between the gearsets enables the vehicle to travel at different vehicle speeds for a given engine speed.

In addition to changing between the gearsets, the automatic transmission is also used to modulate engagement with the engine, whereby the transmission can selectively control engagement with the engine so as to facilitate vehicle operation. By way of example, torque translation between the engine and the automatic transmission is typically interrupted while the vehicle is parked or idling, or when the transmission changes between the gearsets. In conventional automatic transmissions, modulation is achieved via a hydrodynamic device such as a hydraulic torque converter. However, modern automatic transmissions may replace the torque converter with one or more electronically and/or hydraulically actuated clutches (sometimes referred to in the art as a “dual clutch” automatic transmission). Automatic transmissions are typically controlled using hydraulic fluid, and include a pump assembly, one or more hydraulic solenoid valves, and an electronic controller. The pump assembly provides a source of fluid power to the solenoid valves which, in turn, are actuated by the controller so as to selectively direct hydraulic fluid throughout the automatic transmission to control modulation of rotational torque generated by the output of the engine. The solenoid valves are also typically used to change between the gearsets of the automatic transmission, and may also be used to control hydraulic fluid used to cool and/or lubricate various components of the transmission in operation.

One type of automatic transmission is known as a continuously variable transmission (CVT). In general, such transmissions take the form of two adjustable pulleys, each pulley having a sheave which is axially fixed and another sheave which is axially displaceable or movable relative to the fixed sheave. A flexible belt of metal or elastomeric material or a chain is used to intercouple the pulleys. The interior faces of the pulley sheaves are beveled or chamfered so that, as the axially displaceable sheave is moved, the distance between the sheaves and thus the effective pulley diameter is adjusted. The displaceable sheave includes a fluid-constraining chamber for receiving fluid to increase the effective pulley diameter, and when fluid is exhausted from the chamber, the pulley diameter is decreased. Generally, the effective diameter of one pulley is adjusted in one direction as the effective diameter of the second pulley is varied in the opposite direction, thereby effecting a change in the drive ratio between an input shaft coupled to an input pulley and an output shaft coupled to an output pulley. As a result, the drive ratio between the shafts is variable in a continuous, smooth manner. The solenoid valves are also typically used to actuate the pulleys of the continuously variable automatic transmission, and may also be used to control hydraulic fluid used to cool and/or lubricate various components of the transmission in operation.

The design or function feasibility of variable force solenoid (VFS) valves used in hydraulic controls for automatic transmissions in automotive vehicles are often constrained by the available packaging space, battery voltage, pressure range, and required flow rates. For example, there are VFS valves with medium pressure (˜20 bar) and medium flow (˜15 lpm) for transmission clutch direct acting controls, VFS valves with low pressure (<10 bar) and low flow (<10 lpm) for two-stage (pilot) controls, and VFS valves with high pressure (>40 bar) and low flow (˜10 lpm) for clean and low viscous fluid environment.

In addition, these solenoid valves have a valve body disposed in a valve bore of a valve housing. The valve bore has a generally single diameter circular cross-section to receive the valve body. The valve housing has a generally rectangular flow path to the valve body and the valve body has two generally arcuate and opposed sides. The existing valve body and valve housing design do not provide large annulus flow area around a spool valve and causes excessive side-load onto the spool valve or valve member in high pressure and high flow applications, which is undesired.

For high-pressure, high-flow, variable force solenoids, the force balance between feedback force, magnet force, spring force, and flow force is critical. Especially with large flow forces in both axial and radial directions, the magnet force is often needed to be larger than the packaging space available in the transmission. Thus, there is a need in the art to provide a high flow high pressure hydraulic solenoid valve that is capable of flowing high flow and regulating high pressure required for controlling the pulleys of the continuously variable automatic transmission.

### SUMMARY OF THE INVENTION

The present invention provides a high flow high pressure hydraulic solenoid valve for use with an automatic transmission. The high flow high pressure hydraulic solenoid valve includes a proportional solenoid and a valve body connected to and operatively associated with the solenoid. The valve body has a valve bore extending axially and at least two fluid ports for fluid communication with the valve bore, wherein one of the at least two fluid ports includes an undercut. The high flow high pressure hydraulic solenoid valve also includes a valve member axially and slidingly disposed within the valve bore. The valve member has a plurality of valve elements spaced axially along the valve member. At least one of the valve elements has a metering face acting with the undercut. The one of the at least two fluid ports has two openings located approximately one hundred eighty (180) degrees from each other in the valve body and the valve member has a control module port configured to be ninety degrees from the at least one fluid port to balance pressure on the valve member during high flow conditions.

Further, the present invention provides a high flow high pressure hydraulic solenoid valve for use in an automatic transmission including a proportional solenoid and a valve body connected to and operatively associated with the solenoid. The valve body has a valve bore extending axially and at least one fluid inlet port for fluid communication with the valve bore and with a source of pressurized hydraulic fluid and at least one fluid outlet port for fluid communication with the valve bore, wherein one of the at least one fluid inlet port and the at least fluid outlet port includes an undercut. The high flow high pressure hydraulic solenoid valve also includes a valve member axially and slidingly disposed within the valve bore. The valve member has a plurality of valve elements spaced axially along the valve member. The valve body has a tombstone shape at the one of the at least one fluid inlet port and the at least one fluid outlet port. The one of the at least one fluid port and the at least one fluid outlet port has two openings located approximately one hundred eighty (180) degrees from each other in the valve body and the valve member has a control module port configured to be ninety degrees from the at least one fluid inlet port and the at least one fluid outlet port to balance pressure on the valve member during high flow conditions.

One advantage of the present invention is that a new high flow high pressure hydraulic solenoid valve is provided for an automatic transmission such as a continuously variable automatic transmission that is capable of flowing high flow and regulating high pressure required for controlling pulleys in the continuously variable automatic transmission. Another advantage of the present invention is that the high flow high pressure hydraulic solenoid valve directly controls pulley pressure, unlike a conventional two-stage (pilot) control system used in pulley controls. Yet another advantage of the present invention is that the high flow high pressure hydraulic solenoid valve includes a valve member such as a spool valve having at least one metering edge which includes specific geometry to minimize hydraulic, steady-state flow forces on the spool valve in high-flow conditions. Still another advantage of the present invention is that the high flow high pressure hydraulic solenoid valve has a valve body with one or more hydraulic ports each having two openings located approximately 180 degrees from each other in the valve body and where the hydraulic ports are furthermore arranged to be 90 degrees from a control module port to balance pressure on the spool valve during high-flow conditions.

### BRIEF DESCRIPTION OF THE DRAWINGS

Other objects, features, and advantages of the present invention will be readily appreciated as the same becomes better understood after reading the subsequent description taken in connection with the accompanying drawings wherein:

FIG. 1 is a schematic view of a vehicle with a powertrain system including a high flow high pressure hydraulic solenoid valve, according to the present invention;

FIG. 2 is a cross-sectional view of one embodiment of the high flow high pressure hydraulic solenoid valve of FIG. 1 with a valve member in a first operational position;

FIG. 3 is a view similar to FIG. 2 illustrating the high flow high pressure hydraulic solenoid valve with the valve member in a second operational position;

FIG. 4 is a view similar to FIG. 2 illustrating the high flow high pressure hydraulic solenoid valve with the valve member in a third operational position;

FIG. 5 is a view similar to FIG. 2 illustrating the high flow high pressure hydraulic solenoid valve with the valve member in a fourth operational position;

FIG. 6 is a perspective view of the valve member of the high flow high pressure hydraulic solenoid valve of FIG. 2; and

FIG. 7 is a sectional view taken along line 7-7 of FIG. 2.

FIG. 8 is a cross-sectional view of the valve member having a flow force compensating shape.

FIG. 9 is a perspective cross-sectional view of the high flow high pressure hydraulic solenoid valve of FIGS. 1-5.

FIG. 10 is a partial perspective view of a portion of the high flow high pressure hydraulic solenoid valve of FIG. 9.

### DETAILED DESCRIPTION OF THE INVENTION

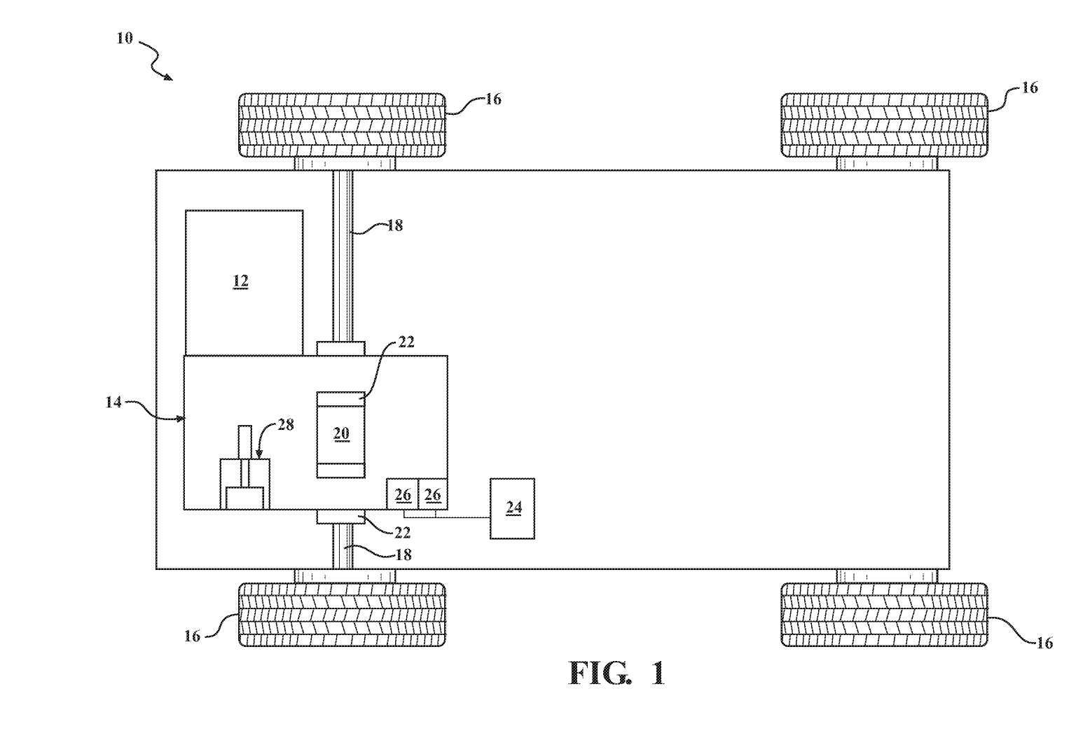

Referring now to the figures, where like numerals are used to designate like structure unless otherwise indicated, a vehicle is schematically illustrated at 10 in FIG. 1. The vehicle 10 includes an engine 12 in rotational communication with a continuously variable automatic transmission 14 of a powertrain system. The engine 12 generates rotational torque which is selectively translated to the continuously variable automatic transmission 14 which, in turn, translates rotational torque to one or more wheels, generally indicated at 16. To that end, a pair of continuously-variable joints 18 translates rotational torque from the continuously variable automatic transmission 14 to the wheels 16. It should be appreciated that the continuously variable automatic transmission 14 of FIG. 1 may be of a type employed in a conventional “transverse front wheel drive” powertrain system for the vehicle 10. It should also be appreciated that the engine 12 and/or continuously variable automatic transmission 14 could be of any suitable type, configured in any suitable way sufficient to generate and translate rotational torque so as to drive the vehicle 10, without departing from the scope of the present invention.

The continuously variable automatic transmission 14 multiplies the rotational speed and torque generated by an output of the engine 12 through a pulley assembly 22. In one embodiment, a forward-reverse gearset 20 is disposed between the engine 12 and the pulley assembly 22. The pulley assembly 22 includes an input or primary pulley (not shown) having a fixed sheave (not shown) and a displaceable or movable sheave (not shown), with a primary sheave servo chamber (not shown) positioned to admit and discharge fluid and thus adjust the position of movable sheave. The pulley assembly 22 also includes a secondary or output pulley (not shown) having an axially fixed sheave (not shown) and an axially displaceable or movable sheave (not shown), with a secondary sheave servo chamber (not shown) positioned to admit and discharge fluid to change the effective diameter of the pulley. The pulley assembly 22 further includes a belt or chain (not shown) intercoupling the pulleys. The output of secondary pulley is passed to a differential assembly (not shown), which passes output drive to the joints 18, in turn, to the wheels 16 of the vehicle. It should be appreciated that this drive train, from the engine 12 to the joints 18 is completed when fluid under pressure is admitted into the starting clutch servo chamber.

In addition, the continuously variable automatic transmission 14 is also used to modulate engagement with the engine 12, whereby the transmission 14 can selectively control engagement with the engine 12 so as to facilitate vehicle operation. By way of example, torque translation between the engine 12 and the continuously variable automatic transmission 14 is typically interrupted while the vehicle 10 is parked or idling, or when the transmission 14 changes between gears of the gearset 20. In the continuously variable automatic transmission 14, modulation of rational torque between the engine 12 and transmission 14 is achieved via a hydrodynamic device such as a hydraulic torque converter (not shown, but generally known in the art). An example of a continuously variable (automatic) transmission (CVT) 14 is disclosed in U.S. Pat. No. 4,712,453 to Haley, the disclosure of which is hereby incorporated by reference in its entirety. It should be appreciated that the continuously variable automatic transmission 14 is adapted for use with vehicles such as automotive vehicles, but could be used in connection with any suitable type of vehicle. It should also be appreciated, in some CVTs, the torque converter is replaced and used with a starting clutch.

Irrespective of the specific configuration of the powertrain system, the continuously variable automatic transmission 14 is typically controlled using hydraulic fluid. Specifically, the continuously variable automatic transmission 14 is cooled, lubricated, and actuated, and modulates torque using hydraulic fluid. To these ends, the continuously variable automatic transmission 14 typically includes an electronic controller 24 in electrical communication with one or more hydraulic solenoid valves 26 (see FIG. 1) used to direct, control, or otherwise regulate flow of fluid throughout the transmission 14, as described in greater detail below. In order to facilitate the flow of hydraulic fluid throughout the continuously variable automatic transmission 14, the vehicle 10 includes at least one or more pumps, generally indicated at 28, to supply pressurized fluid to the transmission 14. It should be appreciated that the pump 28 provides high flow high pressure hydraulic fluid to the solenoid valves 26.

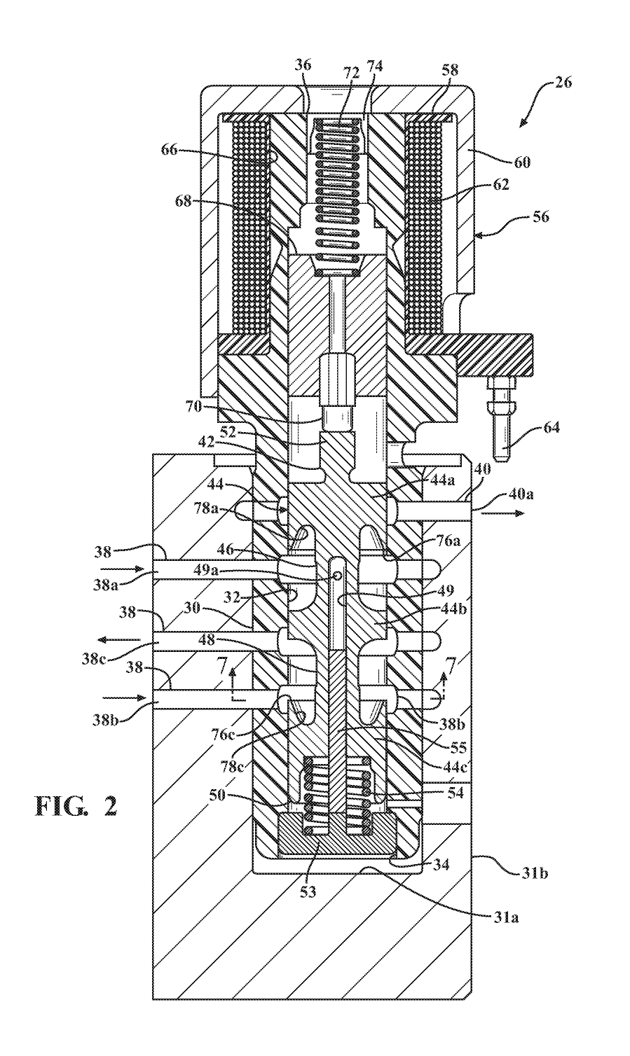

Referring now to FIG. 2, one embodiment of a high flow high pressure hydraulic solenoid valve 26, according to the present invention, is shown in connection with the automatic transmission 14. The solenoid valve 26 includes a sleeve or valve body 30 disposed in a bore 31a of a valve housing 31b. The valve body 30 has a valve bore 32. The valve bore 32 has a biasing end 34 and an actuating end 36. The valve body 30 also includes at least one inlet 38 and at least one outlet 40 adapted to provide fluid communication with a source of pressurized hydraulic fluid and a return to the source of pressure such as the pump 28. Specifically, the valve body 30 includes a first pressure control port 38a, a second pressure control port 38b, a pressure supply port 38c, and an exhaust port 40a. The operative connections of the ports will be discussed subsequently.

The solenoid valve 26 also includes a valve member 42 or a spool valve (i.e., hydraulic control valve) slideably disposed within the valve bore 32 of the valve body 30. The valve member 42 has a plurality of valve elements, generally indicated at 44. The valve elements 44 are adapted to control the flow of pressurized hydraulic fluid between the ports of the valve body 30. In one embodiment, the valve elements 44 are three valve elements 44a, 44b, and 44c operatively separated by first and second areas of reduced diameter, 46 and 48, respectively. The valve member 42 further includes a biasing end 50 and an actuating end 52. The valve member 42 also includes a cavity 49 extending axially into the biasing end 50 and a control module port 49a fluidly communicating with the cavity 49 and the valve bore 32 of the valve body 30. It should be appreciated that the valve member 42 is integral, unitary, and one-piece. It should also be appreciated that the control module port 49a is configured to be ninety degrees from at least one fluid port to balance pressure on the valve member 42 during high flow conditions.

The solenoid valve 26 further includes a biasing return spring 54 disposed in the valve bore 32 between the biasing end 50 of the valve member 42 and the biasing end 34 of the valve bore 32. The solenoid valve 26 includes an end member 53 disposed in the biasing end 34 of the valve bore 32 and a guide pin or rod 55 extending from the end member 53 and into the cavity 49 of the valve member 42. It should be appreciated that the end member 53 and guide rod 55 are fixed and the valve member 42 moves axially along and relative to the guide rod 55.

The solenoid valve 26 also includes an electronically controlled solenoid 56 for actuating the valve member 42 to control hydraulic fluid pressure between the first control pressure port 38a, the second pressure control port 38b, the pressure supply port 38c, and the exhaust port 40a. The solenoid 56 includes a bobbin 58 and a housing 60 enclosing the bobbin 58. The bobbin 58 has a primary electromagnetic coil 62 wound thereon to create a magnetic field when energized. The solenoid 56 also includes a terminal 64 for connecting with the electromagnetic coil 62 and to ground (not shown). It should be appreciated that the terminal 64 receives a continuous variable, digital control signal from a primary driver (not shown) such as the electronic controller 24.

Accordingly, the electromagnetic coil 62 is independently controlled by respective continuous variable, digital control signals. The electronic controller 24 is connected to a pair of contacts (not shown) that is attached to the housing 60 of the solenoid 56. When engine conditions require clutching of the transmission 14, the electronic controller 24 inputs a control signal to the solenoid 56 via the contacts and the terminal 64. The electronic controller 24 automatically controls actuation during automatic shifts. It should be appreciated that the electronic controller 24 could also be used for the vehicle 10 stopped on hills or the like. It should also be appreciated that the electronic controller 24 can function to sense the occurrence of a manual shift and send a signal to the solenoid 56 for actuating the solenoid valve 26.

The solenoid 56 further includes an internal diameter or aperture 66 extending through the longitudinal axis of the bobbin 58. The actuating end 36 of the valve body 30 is disposed in the channel 66. The solenoid 56 includes an armature 68 co-axially disposed within the valve bore 32 and an actuator rod 70 is disposed through and slides co-axially with the armature 68. The solenoid 56 further includes an armature spring 72 located at an end of the armature 68 opposite the valve member 42. The armature spring 72 biases the armature 68 in a generally outward direction towards the valve member 42. It should be appreciated that a fastener 74 is connectable to the armature spring 72 and allows for mechanical adjustment of the force exerted by the armature spring 72 on the armature 68. It should also be appreciated that when the electromagnetic coil 62 is energized, the magnetic field moves the armature 68.

The solenoid valve 26 of the present invention includes flow force compensation with a meter-out configuration. The transmission 14 of the present invention includes the solenoid valve 26 having a meter-out configuration that provides stability in response to transient flow forces and further includes flow force compensation that provides stable and accurate pressure regulation by overcoming the effects of the steady state flow forces, as well.

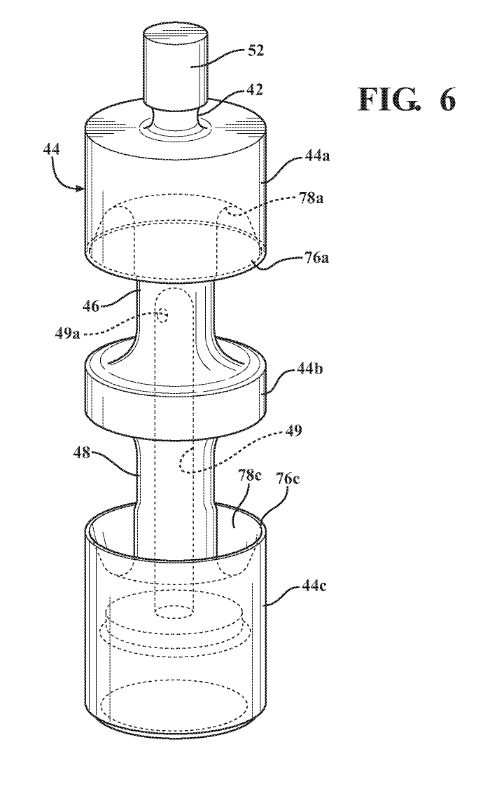

To achieve flow force compensation, the valve member 42 of the present invention further includes a flow force compensating shape as illustrated in FIGS. 2 through 6. More specifically, the valve member 42 includes at least two of the valve elements 44 having a metering face 76. The valve element 44a has a metering face 76a adapted to control the flow of the pressurized hydraulic fluid between the first pressure control port 38a and the exhaust port 40a. The valve element 44c has a metering face 76c adapted to control the flow of the pressurized hydraulic fluid between the second pressure control port 38b and the pressure supply port 38c. The metering face 76a includes a flow force compensating annular void 78a and the metering face 76c includes a flow force compensating annular void 78c opposing the flow force compensating annular void 78a. It should be appreciated that the flow force compensating shape may be similar to that disclosed in U.S. Pat. No. 7,431,043 to Xiang et al., the disclosure of which is hereby expressly incorporated by reference.

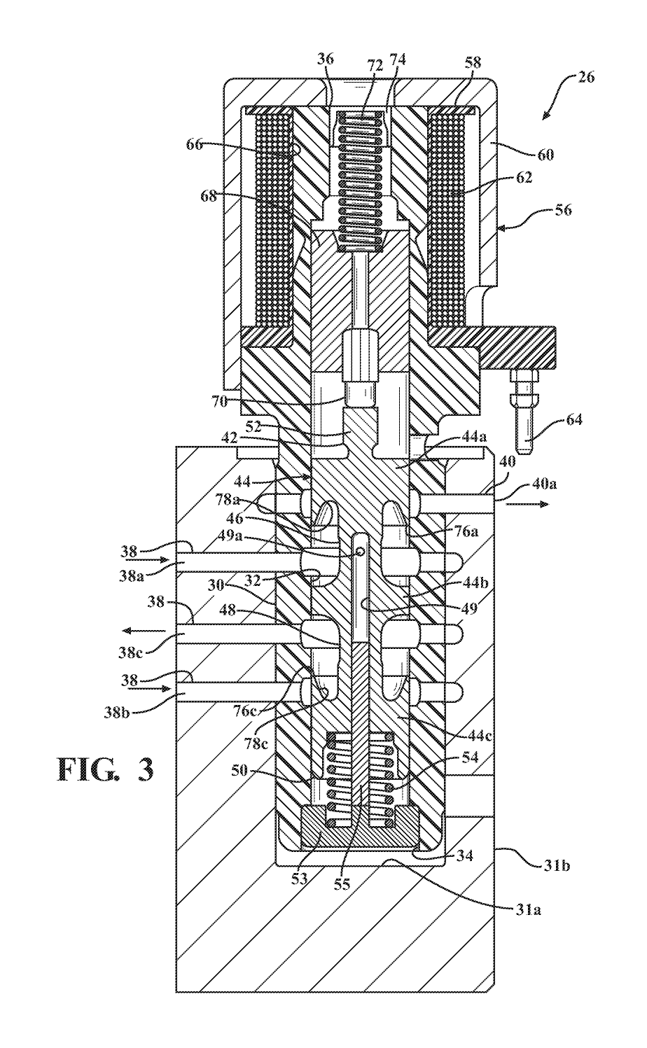

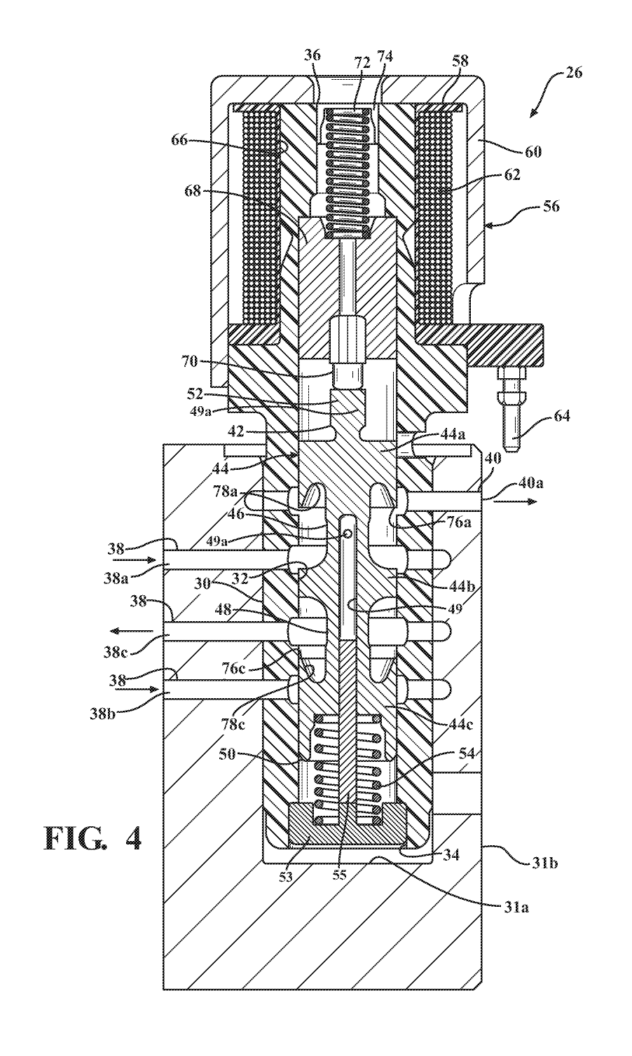

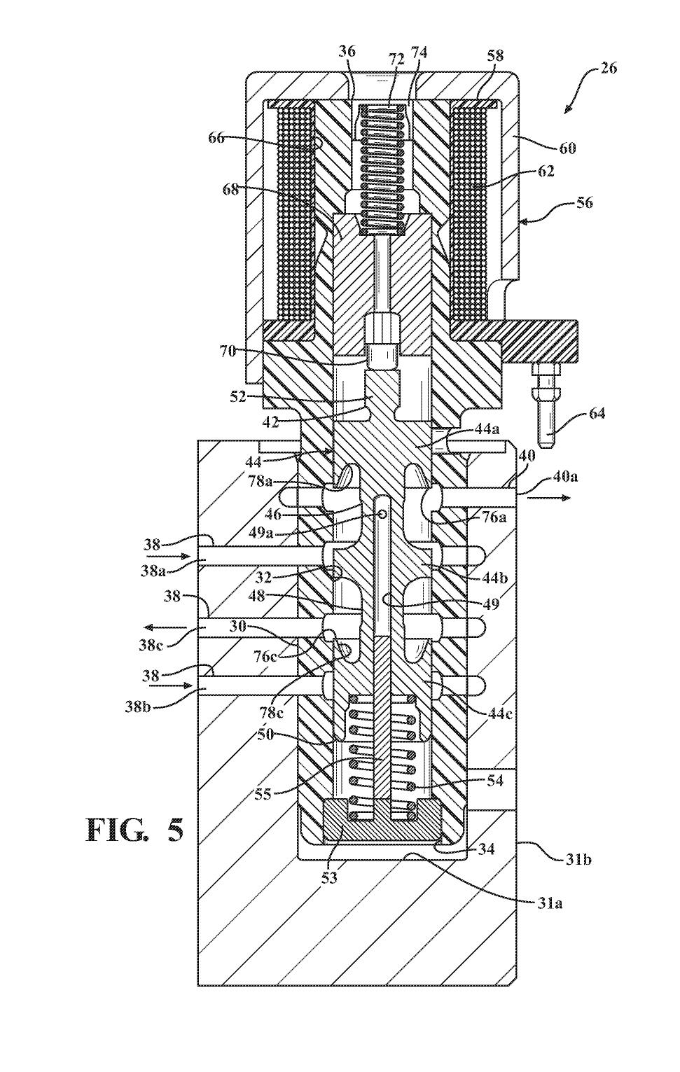

In FIG. 2, the solenoid valve 26 is shown in a first operational position. In this position, the valve element 44a of the valve member 42 closes the exhaust port 40a and the valve element 44c of the valve member 42 partially opens the second pressure control port 38b. As illustrated in FIG. 3, the solenoid valve 26 is shown in a second operational position. In this position, the valve element 44a of the valve member 42 closes the exhaust port 40a and the valve element 44c of the valve member 42 closes the second pressure control port 38b. As illustrated in FIG. 4, the solenoid valve 26 is shown in a third operational position. In this position, the valve element 44a of the valve member 42 partially opens the exhaust port 40a and the valve element 44c of the valve member 42 closes the second pressure control port 38b. As illustrated in FIG. 5, the solenoid valve 26 is shown in a fourth operational position. In this position, the valve element 44a of the valve member 42 fully opens the exhaust port 40a and the valve element 44c of the valve member 42 closes the second pressure control port 38b. It should be appreciated that the hydraulic supply pressure is further communicated to the various control and actuating components such as the pulleys of the transmission 14. It should also be appreciated that the valve member 42 is constantly moving with pressure changes and between the positions illustrated.

One approach relates to a valve member and port interaction that is known as a “meter-in” configuration, in which the valve member is designed to move across and meter the line pressure on its line (inlet) port with the return or suction port of the valve open and unrestricted. A meter-in configuration provides good control over the steady state flow but is generally unstable in regulating transient flow force. The other approach is known as a “meter-out” configuration. With a meter-out configuration, the valve member is designed to move across and meter the line pressure on the suction (outlet) port with the line inlet port of the valve open and unrestricted. A meter-out configuration provides good control during transient flow force conditions, but offers less stable control of the steady state flow force. It be further appreciated that flow path is a meter-out flow path whereas the inlet port 38a is open and the first valve element 44a meters the flow across the outlet port 40a or the inlet port 38c is open and the first valve element 44a meters the flow across the outlet port 38b. It should also be appreciated that the meter-out configuration is better adapted to provide good valve stability during changes in transient flow forces.

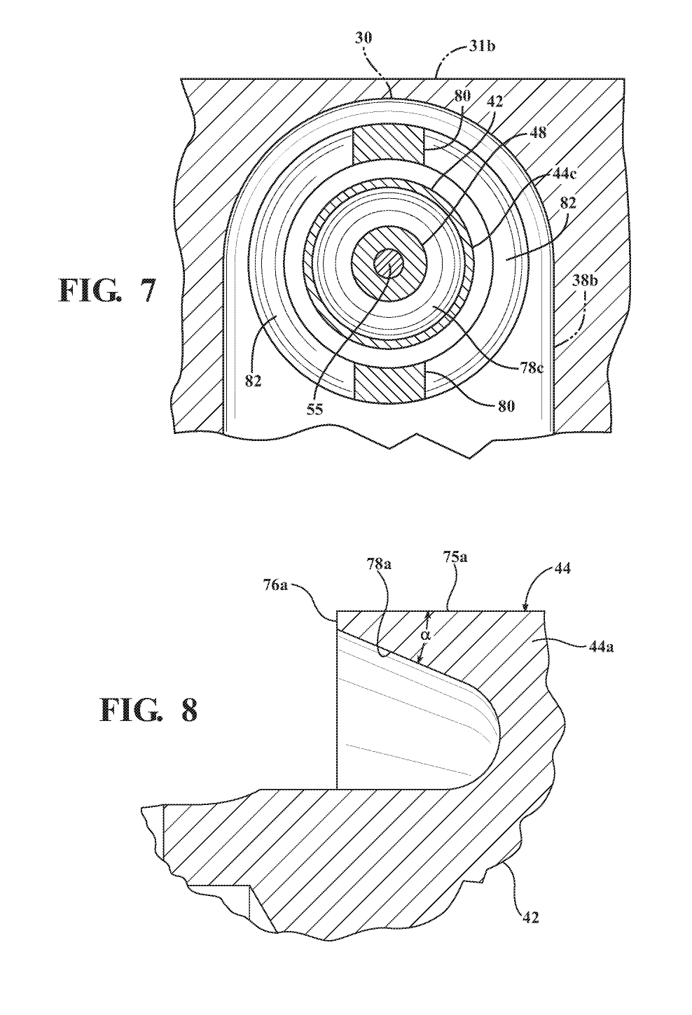

Referring to FIGS. 2 and 7, a portion of the valve body 30 and valve element 42 is shown. The valve member 42 is disposed in the valve bore 32 and axially movable along an axis. Typically, the pressure supply port 38c is fluidly connected with a source of pressurized hydraulic fluid to be metered out to a control pressure port 38a, 38b or is a control pressure to be metered out to an exhaust pressure port 40a. The valve member 42 has a valve element 44 for metering fluid between the second pressure control port 38b and the pressure supply port 38c. To connect the second pressure control port 38b with the pressure supply port 38c, the valve member 42 is moved in a direction that the valve element 44c enters the second control pressure port 38b gradually opening hydraulic communication from the pressure supply port 38c to the second pressure control port 38b. It should be appreciated that fluid from the first pressure control port 38a flows into the control module port 49a and fills up the cavity 49 to create feedback to balance pressure on the valve member 42 during high flow conditions and provide stability in response to transient flow forces.

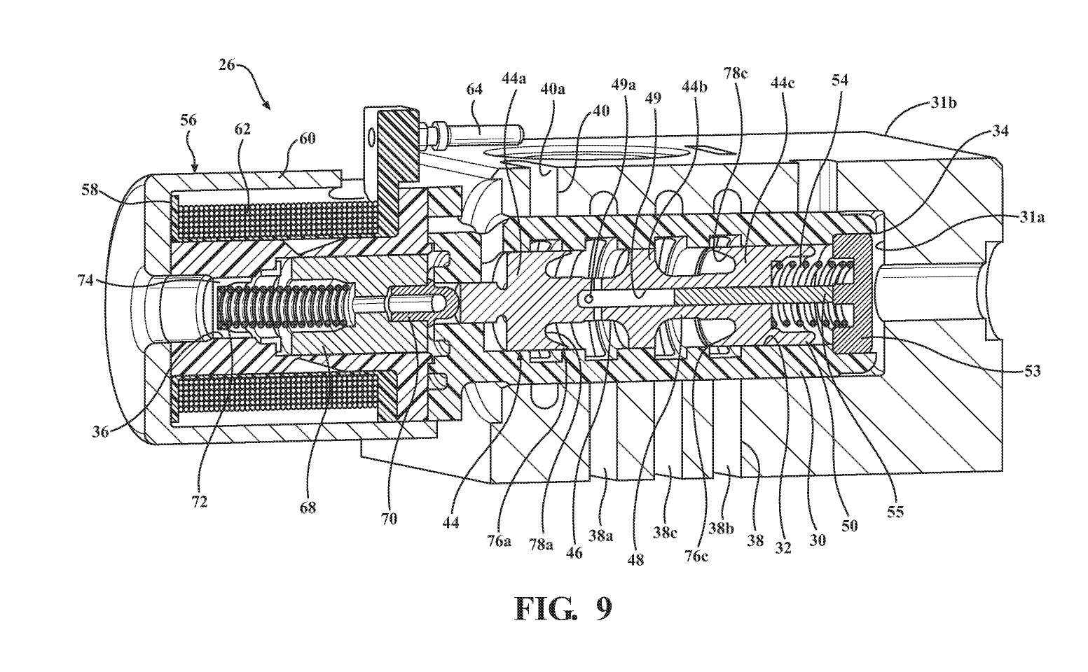

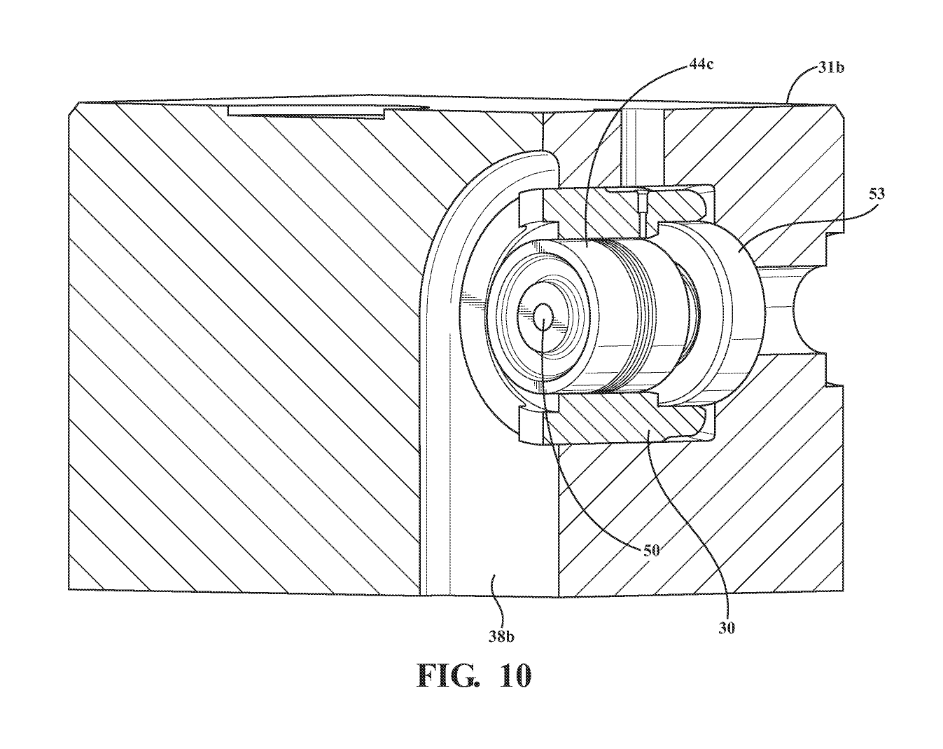

Referring to FIGS. 7, 9, and 10, an enlargement of the spatial fluid control pressure port 38b is shown. As illustrated, the valve body 30 has a relatively large and general “tombstone” shape. The fluid port 38b has two symmetrically spaced flow openings or plenums 82 in the valve body 30 oriented one hundred eighty (180) degrees from each other. The openings 82 are generally semi-circular in shape and extend generally in a plane perpendicular to an axis of the valve member 42. Fluid initially enters the second pressure control port 38b at the openings 82 and contacts two shaped control edges 80 oriented one hundred eighty (180) degrees from each other. As the valve element 44c enters further into the second pressure control port 38b, eventually, fluid may enter along the full 360 degree perimeter of the valve element 44c, it should be appreciated that the openings 82 are sized to be substantially unrestrictive to flow and therefore even at extreme flow rates, the pressure drop from one end of the opening 82 to the other is minimal. It should also be appreciated that the fluid port 38b is much more balanced around the valve member 42 as it slides within the valve body 30 and therefore excessive friction and wear is greatly diminished or eliminated.

As illustrated in FIG. 8, to achieve flow force compensation, the valve member 42 of the present invention further includes at least one valve element 44a, 44c having a flow force compensation void, only one of which will be described in detail. The valve element 44a has an outer diameter 75a and a metering face 76a. The metering face 76a is adapted to control the flow of the pressurized hydraulic fluid between the fluid inlet port 38a and the fluid outlet port 40a. The metering face 76a includes a flow force compensating annular void 78a disposed adjacent the outer diameter 75a of the valve element 44a and defined by a lead angle “α” measured between the outer diameter 75a and a line intersecting the outer diameter 75a and tangential to the annular void 78a. To provide an appreciable effect, the lead angle α is less than ninety (90) degrees, preferably between fifteen (15) degrees and seventy (70) degrees depending on optimization compensation of pressure versus temperature, more preferably less than forty-five (45) degrees. The metering face 76a has a radial thickness greater than 0.5 millimeters. It should be appreciated that it is desirable to form the metering face 76a as a knife edge, but to due to manufacturing processes, the metering face 76 must not be less than 0.5 millimeters

It has also been found that providing any lead angle α less than 90 degrees provides some decrease in the flow force effects on the valve member 42. However, the flow forces acting upon the valve member 42 decay monotonically with respect to the decrease in lead angle α. Therefore, the smaller the lead angle α and the thereby the deeper the annular void 78a in the metering face 76a, 76c, the greater the reduction in flow force. It should be appreciated that manufacturing limitations and costs may impact the lead angle chosen in the production of the solenoid valve of the present invention. Specifically, while the flow forces may be completely compensated for, in theory, by providing a lead angle α as close to possible to 0 degrees, the monotonically decaying improvement in compensation provides diminishing improvements at the smaller lead angles and may prove more costly or impractical to manufacture. It should be appreciated that the lead angle α employed in the preferred embodiment will be continually reduced as manufacturing techniques and processes improve and make smaller lead angles more economically feasible. Thus, the solenoid valve of the present invention includes flow force compensation that provides high valve stability and accurate and stable fluid flow with regard to the flow force effects upon the valve member 42 during both steady state and transient regulating conditions.

The present invention has been described in an illustrative manner. It is to be understood that the terminology which has been used is intended to be in the nature of words of description rather than of limitation.

Many modifications and variations of the present invention are possible in light of the above teachings. Therefore, within the scope of the appended claims, the invention may be practiced other than as specifically described.

1. A high flow high pressure hydraulic solenoid valve (26) for use in an automatic transmission (14), said solenoid valve (26) comprising:
a proportional solenoid (56);
a valve body (30) connected to and operatively associated with said solenoid (56), said valve body (30) having a valve bore (32) extending axially and at least two fluid ports (38, 40) for fluid communication with said valve bore (32), wherein one of said at least two fluid ports (38, 40) includes an undercut (38b, 40b);
a valve member (42) axially and slidingly disposed within said valve bore (32), said valve member (42) having a plurality of valve elements (44) spaced axially along said valve member (42), at least one of said valve elements (44) having a metering face (76a, 76c) acting with said undercut (38b, 40b);
wherein said one of said at least two fluid ports (38, 40) has two openings (82) located approximately one hundred eighty (180) degrees from each other in said valve body (30); and
wherein said valve member (42) has a control module port (49a) configured to be ninety degrees from the one of said at least one fluid ports (38, 40) to balance pressure on the valve member (42) during high flow conditions.

2. A high flow high pressure hydraulic solenoid valve (26) as set forth in claim 1 wherein said two openings (82) have a generally semi-circular cross-sectional shape.

3. A high flow high pressure hydraulic solenoid valve (26) as set forth in claim 1 wherein said valve body (30) has a tombstone shape at said one of said at least two fluid ports (38, 40).

4. A high flow high pressure hydraulic solenoid valve (26) as set forth in claim 1 wherein said at least one of said valve elements (44) includes a first valve element (44a), a second valve element (44b), and a third valve element (44c), a first area of reduced diameter (46) disposed axially between said first valve element (44a) and said second valve element (44b) and a second area of reduced diameter (48) disposed axially between said second valve element (44b) and said third valve element (44c).

5. A high flow high pressure hydraulic solenoid valve (26) as set forth in claim 4 wherein said first valve element (44a) includes said metering face (76a) juxtaposed to said first area of reduced diameter (46).

6. A high flow high pressure hydraulic solenoid valve (26) as set forth in claim 4 wherein said third valve element (44c) includes said metering face (76c) juxtaposed to said second area of reduced diameter (48).

7. A high flow high pressure hydraulic solenoid valve (26) for use in an automatic transmission (14), said solenoid valve (26) comprising:
a proportional solenoid (56);
a valve body (30) connected to and operatively associated with said solenoid (56), said valve body (30) having a valve bore (32) extending axially and at least one fluid inlet port (38) for fluid communication with said valve bore (32) and with a source of pressurized hydraulic fluid and at least one fluid outlet port (40) for fluid communication with said valve bore (32), wherein one of said at least one fluid inlet port (38) and said at least one fluid outlet port (40) includes an undercut (38b, 40b);
a valve member (42) axially and slidingly disposed within said valve bore (32), said valve member (42) having a plurality of valve elements (44) spaced axially along said valve member (42);
wherein said valve body (30) has a tombstone shape at said one of said at least one fluid inlet port (38) and said at least one fluid outlet port (40);
wherein said one of said at least one fluid inlet port (38) and said at least one fluid outlet port (40) has two openings (82) located approximately one hundred eighty (180) degrees from each other in said valve body (30); and
wherein said valve member (42) has a control module port (49a) configured to be ninety degrees from said at least one fluid port (38) and said at least one fluid outlet port (40) to balance pressure on the valve member (42) during high flow conditions.

8. A high flow high pressure hydraulic solenoid valve (26) as set forth in claim 7 wherein said valve elements (44) includes a first valve element (44a), a second valve element (44b), and a third valve element (44c), a first area of reduced diameter (46) disposed axially between said first valve element (44a) and said second valve element (44b) and a second area of reduced diameter (48) disposed axially between said second valve element (44b) and said third valve element (44c).

9. A high flow high pressure hydraulic solenoid valve (26) as set forth in claim 8 wherein said first valve element (44a) includes a first metering face (76a) juxtaposed to said first area of reduced diameter (46).

10. A high flow high pressure hydraulic solenoid valve (26) as set forth in claim 9 wherein said third valve element (44c) includes a second metering face (76c) juxtaposed to said second area of reduced diameter (48).

11. A high flow high pressure hydraulic solenoid valve (26) as set forth in claim 7 wherein said two openings (82) have a generally semi-circular cross-sectional shape.

12. A high flow high pressure hydraulic solenoid valve (26) as set forth in claim 7 wherein fluid initially enters said one of said at least one fluid inlet port (38) and said at least one fluid outlet port (40) fluid at said openings (82) and contacts two shaped control edges (80) oriented one hundred eighty (180) degrees from each other.

13. A high flow high pressure hydraulic solenoid valve (26) for use in an automatic transmission (14), said solenoid valve (26) comprising:
a proportional solenoid (56);
a valve body (30) connected to and operatively associated with said solenoid (56), said valve body (30) having a valve bore (32) extending axially and at least one fluid inlet port (38) for fluid communication with said valve bore (32) and with a source of pressurized hydraulic fluid and at least one fluid outlet port (40) for fluid communication with said valve bore (32), wherein one of said at least one fluid inlet port (38) and said at least one fluid outlet port (40) includes an undercut (38b, 40b);
a valve member (42) axially and slidingly disposed within said valve bore (32), said valve member (42) having a plurality of valve elements (44) spaced axially along said valve member (42), wherein said valve elements (44) includes a first valve element (44a), a second valve element (44b), and a third valve element (44c), a first area of reduced diameter (46) disposed axially between said first valve element (44a) and said second valve element (44b) and a second area of reduced diameter (48) disposed axially between said second valve element (44b) and said third valve element (44c), wherein said first valve element (44a) includes a first metering face (76a) juxtaposed to said first area of reduced diameter (46) and said third valve element (44c) includes a second metering face (76c) juxtaposed to said second area of reduced diameter (48);
wherein said valve body (30) has a tombstone shape at said one of said at least one fluid inlet port (38) and said at least one fluid outlet port (40);
wherein said one of said at least one fluid inlet port (38) and said at least one fluid outlet port (40) has two openings (82) located approximately one hundred eighty (180) degrees from each other in said valve body (30); and
wherein said valve member (42) has a control module port (49a) configured to be ninety degrees from said at least one fluid port (38) and said at least one fluid outlet port (40) to balance pressure on the valve member (42) during high flow conditions.

14. A high flow high pressure hydraulic solenoid valve (26) as set forth in claim 13 wherein said two openings (82) have a generally semi-circular cross-sectional shape.

15. A high flow high pressure hydraulic solenoid valve (26) as set forth in claim 13 wherein fluid initially enters said one of said at least one fluid inlet port (38) and said at least one fluid outlet port (40) fluid at said openings (82) and contacts two shaped control edges (80) oriented one hundred eighty (180) degrees from each other.
